(19) United States
(12) Patent Application Publication
(10) Pub. No.: US 2023/0357004 A1
(43) Pub. Date: Nov. 9, 2023

(54) A METHOD FOR THE PRODUCTION OF HYDROGEN

(71) Applicant: TYKHE TECH PTE. LTD., Singapore (SG)

(72) Inventor: Srecko VUKSAN, Khlong Luang Pathumthani (TH)

(73) Assignee: TYKHE TECH PTE. LTD., Singapore (SG)

(21) Appl. No.: 18/245,462

(22) PCT Filed: Oct. 19, 2021
(86) PCT No.: PCT/IL2021/051239

§ 371 Date: Mar. 15, 2023

(30) Foreign Application Priority Data
Oct. 20, 2020 (IL) 278192

(51) Int. Cl. C01B 3/06

(52) U.S. Cl. CPC C01B 3/061

(57) ABSTRACT

The present invention relates to a process of producing hydrogen gas from water, an iron-containing coal combustion product and carbon dioxide or a carbon dioxide precursor. The process is a spontaneous process that does not involve the implementation of external heating or electricity. The process further provides the recycling of the coal combustion product such as an iron slag or ash and may also be used for carbon dioxide sequestering.

### FIELD OF THE INVENTION

The present invention relates to a spontaneous process of producing hydrogen gas from water in the presence of an iron-containing ash or slag and carbon dioxide (CO₂) or a carbon dioxide precursor.

### BACKGROUND OF THE INVENTION

Hydrogen (H₂) is one of the key starting materials used in the chemical industry. It is also considered as the most likely alternative for fossil fuels in transportation, particularly due to its high energy-to-weight ratio and clean combustion products (water). Over 65 million metric tons of commercial hydrogen are produced today with the bulk of the production using fossil fuel, or biomass, in addition to water as resources. Approximately 95% of production relies upon steam methane (CH₄) reforming (SMR) or other methods utilizing fossil fuels. SMR involves mixing superheated steam (H₂O) (700° C. to 1,100° C.) with de-sulfurized natural gas in a reforming reaction to produce hydrogen and carbon monoxide (CO). The carbon monoxide then interacts with steam in a water shift reaction to produce hydrogen and carbon dioxide. Overall, steam methane reforming is only 65% to 75% efficient, with a significant portion of the methane remaining unreacted throughout the process. In addition, this process has a large carbon footprint, as the production of a single kilogram (kg) of hydrogen gas generates about 7 kg of carbon dioxide (CO₂) emission.

European patent EP 3194331 describes a process for the synthesis of hydrogen gas (H₂) in a reactor under hydrothermal conditions, comprising: (a) contacting metallic iron (Fe⁰) and/or a Fe^{(II)} comprising compound with an aqueous composition having a pH of 6.5 or higher and comprising carbonate and bicarbonate ions in a total concentration of at least 0.01 M, thereby obtaining a reaction mixture; and subjecting said reaction mixture to hydrothermal conditions; (b) reacting said reaction mixture at a reaction temperature above 120° C. and not exceeding 240° C. and a pressure between 1 bar and 70 bar; thereby obtaining magnetite and hydrogen gas.

JP 2004196581 describes a method for producing hydrogen by reacting water with carbon dioxide under a non-oxidation atmosphere in the presence of aluminum oxide on which potassium, aluminum and metal iron are supported as a metal iron catalyst.

JP 2007031169 describes a hydrogen production method comprising activating a metal by applying a mechanical impact or stress having the magnitude capable of twisting, deforming or destroying a substance containing the metal or a low valent metal in the presence of water to generate hydrogen. A method of immobilizing carbon dioxide which comprises introducing and interposing carbon dioxide together with water in the above process and converting it into a stable metal carbonate is provided as well.

Carbon dioxide is one of the most significant greenhouse gases (GHG) in the Earth's atmosphere with current global average concentration of 409 ppm (0.041%) by volume, or 622 ppm (0.062%) by mass. Human activities emit approximately 30 billion tons of CO₂ every year, half of which remains in the atmosphere as a GHG and is not absorbed by vegetation and/or the oceans. One of the challenges of the 21^{st} century is to meet the increasing energy needs of a continuously growing population and economy while simultaneously decreasing carbon dioxide emissions. Carbon dioxide (CO₂) Capture and Storage, also referred to as Carbon Capture and Sequestration (CCS) is the process of managing produced CO₂ (mainly from combustion waste emitted from large point sources, such as fossil fuel power plants), transporting it to a storage site, and depositing it in a manner that prevents the CO₂ from re-entering the atmosphere. Post-production CCS, i.e., removal of the CO₂ after combustion, is considered one of the most promising strategies to achieve this objective. Currently available technologies, however, can raise energy costs by 30% to 70% (Leung et al., Renewable and Sustainable Energy Reviews 39 (2014) 426-443) and are therefore considered prohibitively expensive and have yet to be widely implemented.

Most captured CO₂ is used in enhanced oil recovery (EOR) to recover additional oil from underground oil fields where the CO₂ is then permanently stored. This use is limited in scope and constrained by the availability of appropriate Earth's natural resources and transportation costs. The global size of the CO₂ re-use market (in carbonate aggregates, fuels, concrete, methanol, and polymers) is estimated to reach $700 billion by 2030, utilizing 7 billion metric tons of CO₂ per year, the equivalent to approximately half of the annual amount of CO₂ which remains in the atmosphere due to human activities (or 15% of current global CO₂ emissions).

Michiels et al. (Fuel 160 (2015) 205-216) describes a carbon dioxide based hydrothermal process for the production of hydrogen gas from water via the oxidation of pure metallic iron powder, Fe⁰. The process requires substantial addition of external energy, and is performed at elevated temperatures of 160° C. The process also requires chemical grade Fe⁰ powder as a starting material, and produces iron(II,III) oxide—Fe₃O₄.

JP 2007075773 describes a system for fixing carbon dioxide by contacting carbon dioxide with metal microparticles, or microparticles of a material comprising a metal component in a lower valence state, or an aggregate thereof in the presence of water and allowing the metal component, carbon dioxide, and water to react with each other, whereby carbon dioxide is converted into a carbonate of the metal component in a higher valence state.

Guan et al. (Green Chemistry 5 (2003) 630-634) describes the reduction of CO₂ over zero-valent Fe⁰ and Fe⁰-based composites in an aqueous solution at room temperature to form H₂ and a small amount of CH₄. When potassium-promoted Fe⁰-based composites, Fe₀—K—Al and Fe⁰—Cu—K—Al, were used, the CO₂ reduction rates were increased and CH₄, C₃H₈, CH₃OH, and C₂H₅OH were produced together with H₂. The fresh and used Fe⁰ powders after the reaction were analyzed by XPS, XRD, and photoemission yield measurements. The obtained results suggest that in the presence of CO₂ as a proton source, zero-valent Fe⁰ is readily oxidized to produce H₂ stoichiometrically, and that CO₂ is reduced catalytically over the Fe⁰-based composites with the resulting H₂ to produce hydrocarbons and alcohols.

Coal combustion products (CCPs), also called coal combustion wastes (CCWs) or coal combustion residuals (CCRs), pose significant environmental concerns. Less than 50% are being recycled while the majority of which are landfilled, placed in mine shafts or stored in ash ponds at coal-fired power plants. CCPs are typically categorized into four categories termed coal ash referring to the collection of residuals produced during the combustion of coal, fly ash referring to a light form of coal ash that floats into the exhaust stacks, bottom ash referring to the heavier portion of coal ash that settles on the ground in the boiler, and boiler slag referring to melted coal ash. The composition of CCPs varies as a result of the coal source and combustion parameters. The main constituent of CCPs is silicon dioxide in the form of silica and quartz constituting approximately 50% by weight of the CCPs. Other components include metal oxides such as calcium oxide, potassium oxide, sodium oxide, aluminum oxide, titanium oxide, and magnesium oxide. Iron (II) oxide, FeO, and iron (III) oxide, Fe₂O₃, as well as iron(II,III) oxide, Fe₃O₄, are also found in CCPs, typically in less than 20 wt. %.

There is still an unmet need for a cost-effective production of hydrogen gas that does not require investment of external heat while affording utilization of CCPs and its recycling.

### SUMMARY OF THE INVENTION

The present invention provides a spontaneous process for producing H₂ comprising contacting water with an iron-containing coal combustion product and a CO₂ source. The process does not involve external heating and is performed in a reactor at a temperature below 100° C., e.g. in the range of −30° C. to 50° C., including at ambient temperature.

The present invention is based in part on the surprising discovery that H₂ can be produced by reacting water, an iron-containing coal combustion product, and carbon dioxide (CO₂) or a carbon dioxide generator at relatively low temperatures without external heating. The process can further be used for recycling of coal combustion products and in carbon dioxide capture and storage. Whereas the hitherto known processes utilized high temperatures and/or zero or low-valent iron to generate hydrogen, the inventor of the present invention has unexpectedly found that it is possible to produce hydrogen at room temperature while using high valent iron oxides from the waste of coal combustion. Hydrogen is produced at high purity while affording recycling of the coal combustion waste which further provides a beneficial environmental advantage.

According to a first aspect, there is provided a process for producing H₂, the process comprising a step of contacting water, an iron-containing coal combustion product, and a CO₂ source selected from the group consisting of CO₂ and a CO₂ precursor thereby producing H₂, wherein the process is performed in a reactor in the absence of external heating.

According to another aspect, there is provided a process for producing H₂ and recycling a coal combustion product or capturing carbon dioxide, the process comprising a step of contacting water, an iron-containing coal combustion product, and a CO₂ source selected from the group consisting of CO₂ and a CO₂ precursor thereby producing H₂ and recycling a coal combustion product or capturing carbon dioxide, wherein the process is performed in a reactor in the absence of external heating.

In one embodiment, the process is performed with no addition of external electric energy. In another embodiment, the process is performed with no addition of external energy.

In some embodiments, the process further comprises a step of collecting the produced H₂. In other embodiments, the process further comprises a step of post-treating the produced H₂. In particular embodiments, post-treatment comprises at least one of gas separation, filtration, and drying. Each possibility represents a separate embodiment. In further embodiments, the produced H₂ has purity of at least about 85%.

In certain embodiments, the water is in a liquid phase. In various embodiments, the water is selected from the group consisting of tap water, sea water, partially purified water, deionized water, distilled water, brackish water, and waste water. Each possibility represents a separate embodiment.

In other embodiments, the iron-containing coal combustion product is selected from the group consisting of coal ash, fly ash, bottom ash, boiler slag, and a mixture or combination thereof. Each possibility represents a separate embodiment. In particular embodiments, the iron-containing coal combustion product originates from a power plant, a fuel boiler, or from cement production. Each possibility represents a separate embodiment. According to some embodiments, the power plant or boiler is fired by coal or heavy oils. In several embodiments, the iron-containing coal combustion product comprises a divalent iron oxide, a trivalent iron oxide or a combination thereof. Each possibility represents a separate embodiment. In one embodiment, the iron-containing coal combustion product comprises a trivalent iron oxide. In specific embodiments, the iron-containing coal combustion product comprises at least one of iron(II) oxide (FeO), iron(II,III) oxide (Fe₃O₄), and iron(III) oxide (Fe₂O₃). Each possibility represents a separate embodiment.

In some embodiments, the iron-containing coal combustion product comprises from about 2% to about 40% iron oxide w/w, including each value within the specified range. In other embodiments, the iron-containing coal combustion product comprises from about 5% to about 30% iron oxide w/w, including each value within the specified range. In exemplary embodiments, the iron-containing coal combustion product comprises less than 25% iron oxide w/w. In further embodiments, the iron-containing coal combustion product comprises from about 25% to about 75% silicon dioxide w/w, including each value within the specified range. In additional embodiments, the weight ratio between the iron oxide and the silicon dioxide in the iron-containing coal combustion product is in the range of about 1:1.5 to about 1:10, including all iterations of ratios within the specified range.

In specific embodiments, the process further comprises pretreating the iron-containing coal combustion product prior to the step of contacting the water, the iron-containing coal combustion product, and the CO₂ source. In some embodiments, pretreating comprises at least one of milling the iron-containing coal combustion product and enriching the iron content in the iron-containing coal combustion product. Each possibility represents a separate embodiment. In particular embodiments, the iron-containing coal combustion product is milled to an average particle size of less than about 100 μm, less than about 75 μm, less than about 50 μm, less than about 25 μm, less than about 10 μm, or even less than about 5 μm. Each possibility represents a separate embodiment. In particular embodiments, the iron-containing coal combustion product is milled to an average particle size in the range of about 1 μm to about 5 μm, or about 3 μm to about 5 μm, including each value within the specified ranges. In further embodiments, the content of iron in the iron-containing coal combustion product is enriched by 10% or more of its original content. In other embodiments, the process further comprises pretreating at least one of the water and the CO₂ source prior to the step of contacting water, an iron-containing coal combustion product, and a CO₂ source.

In additional embodiments, the CO₂ source is a CO₂ gas. In various embodiments, the CO₂ gas is originated from at least one of pure industrial CO₂, flue gas, a CO₂-producing plant, and atmospheric CO₂. Each possibility represents a separate embodiment. In one embodiment, the CO₂ source is dry ice. In another embodiment, the CO₂ precursor is selected from carbonic acid, a carbonate, a bicarbonate, and a mixture or combination thereof. Each possibility represents a separate embodiment.

In some embodiments, the process is a batch production process. In other embodiments, the process is a continuous production process.

In various embodiments, the process is performed at a pH of 6.5 or less. In other embodiments, the process is performed at a pH of 6 or less. In certain embodiments, the process is performed at a pH of 5.5 or less. In further embodiments, the process is performed at a pH in the range of about 4 to about 6, including each value within the specified range. In particular embodiments, the process is performed at a pH in the range of about 5.7 to about 6, including each value within the specified range. In other embodiments, the process is performed at a pH of at least 6.5, for example at a pH in the range of about 7 to about 10, including each value within the specified range.

In one embodiment, the process is performed at a temperature of 100° C. or less. In some embodiments, the process is performed at a temperature in the range of about −30° C. to about 100° C., including each value within the specified range. In other embodiments, the process is performed at a temperature in the range of about −15° C. to about 100° C., including each value within the specified range. In yet other embodiments, the process is performed at a temperature in the range of about −5° C. to about 100° C., including each value within the specified range. In certain embodiments, the process is performed at a temperature in the range of about −5° C. to about 80° C., including each value within the specified range. In further embodiments, the process is performed at a temperature of about −5° C. to about 50° C., including each value within the specified range. According to the principles of the present invention, the process does not include external heating. In certain embodiments, the process does not include external cooling.

In certain embodiments, the process is performed at a pressure of about 1 Bar to about 350 Bar, including each value within the specified range. In other embodiments, the process is performed at a pressure of about 40 Bar to about 350 Bar, including each value within the specified range. In further embodiments, the process is performed at a pressure of about 1 Bar to about 100 Bar, including each value within the specified range. In yet other embodiments, the process is performed at a pressure of about 100 Bar to about 350 Bar, including each value within the specified range. In additional embodiments, the process is performed at a pressure of about 100 Bar to about 250 Bar, including each value within the specified range.

In various embodiments, the process is performed under continuous mixing.

In some embodiments, the process further comprises adding an anti-caking agent to the reaction. In particular embodiments, the anti-caking agent is selected from the group consisting of tricalcium phosphate, powdered cellulose, magnesium stearate, sodium ferrocyanide, potassium ferrocyanide, calcium ferrocyanide, calcium phosphate, sodium silicate, silicon dioxide, calcium silicate, magnesium trisilicate, talcum powder, sodium aluminosilicate, potassium aluminum silicate, calcium aluminosilicate, bentonite, aluminum silicate, stearic acid, polydimethylsiloxane, and a mixture or combination thereof. Each possibility represents a separate embodiment. It is contemplated that as the iron-containing coal combustion product typically comprises significant amounts of silicon dioxide, the addition of an anti-caking agent may be obviated or reduced, while keeping the process efficient.

In certain embodiments, the process comprises (a) dispersing an iron-containing coal combustion product in water; and (b) adding a CO₂ source to the dispersion of step (a) thereby generating a reaction. In other embodiments, the process comprises (a) supplementing CO₂ from a CO₂ source to the water; and (b) adding an iron-containing coal combustion product to the water supplemented with CO₂ of step (a) thereby generating a reaction.

In some embodiments, the process further comprises a step of adding an acid to the water. In additional embodiments, the process comprises the steps of (a) dispersing the iron-containing coal combustion product in water; (b) adding hydrochloric acid to the dispersion of step (a); and (c) adding a CO₂ source to the dispersion of step (b) thereby producing hydrogen.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The accompanying figures, which are included to provide a further understanding of the invention and are incorporated in and constitute a part of this specification, illustrate embodiments of the invention and together with the description serve to explain the principles of the invention wherein:

FIG. 1 depicts a schematic description of a batch reactor, configured to performing a batch process according to one embodiment of the invention; and

FIG. 2 depicts a schematic description of a continuous flow reactor, configured to performing a continuous process according to another embodiment of the invention.

### DETAILED DESCRIPTION OF THE INVENTION

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide compositions and methods. While potentially serving as a guide for understanding, any reference signs used herein and in the claims shall not be construed as limiting the scope thereof.

It is within the scope of the invention to disclose a method for producing hydrogen from a reaction involving carbon dioxide, water and a coal combustion product such as slag or ash containing oxidized iron, without supplying external heat or electricity to the reaction. The present invention thus provides a spontaneous process by which hydrogen gas can be obtained. The process further comprises the recycling of iron-containing coal combustion waste and, in some embodiments, provides the capturing and storage of carbon dioxide.

It is now disclosed for the first time that the production of hydrogen at room temperatures can be obtained by using high valent oxidized iron species instead of pure iron metal and zero- or low-valent iron-containing particles. Furthermore, production of hydrogen at high purity can be obtained even when using iron waste derived from coal combustion procedures where the iron oxides constitute only a minor component thereof. Further advantages stem from the recycling of the iron waste which would otherwise need to be disposed of with ecological costs to result in an additional environmental benefit. In certain embodiments, recycling of the iron waste comprises the production of iron carbonate, iron oxide, or a combination thereof. In some embodiments, the process of the present invention further comprises capturing CO₂ as a metal complex (e.g. an iron complex) thereby resulting in Carbon Capture and Utilization (CCU) and CO₂ sequestering. The use of an iron-containing coal combustion product reactant has also been surprisingly shown to facilitate the kinetics of the reaction by its inclusion of silicon dioxide useful as an anti-caking agent in relatively high amounts.

According to some aspects and embodiments, there is provided a process for producing H₂, the process comprises a step of admixing water, an iron-containing coal combustion product, and a CO₂ source selected from the group consisting of CO₂ and a CO₂ precursor or generator in a reactor to induce a spontaneous reaction without the use of external heating or electricity. According to other aspects and embodiments, there is provided a process for producing H₂ and recycling a coal combustion product or capturing carbon dioxide, the process comprises a step of admixing water, an iron-containing coal combustion product, and a CO₂ source selected from the group consisting of CO₂ and a CO₂ precursor or generator in a reactor to induce a spontaneous reaction without the use of external heating.

As used herein, the term “in the absence of external heating” is intended to describe delivery of heat to the reaction mixture, which is not spontaneous heat formed upon the progression of the reaction. Specifically, the reaction of the current process is mildly exothermic. Thus, upon the progression of the reaction to form a hydrogen gas, the internal temperature inside a closed reactor is raised spontaneously. Such elevation of temperature is not considered external heating and is therefore not excluded by the phrases “in the absence of external heating”, “without external heating”, “the process does not include external heating” and related phrases. Rather, these phrases are intended to exclude providing additional heating from an external source, such as by an electronic heating element or a burner. Thus, in accordance with these embodiments, the process is devoid of heating the reaction mixture. It is to be understood that an endogenous elevation of temperature of the reaction mixture may occur, and is not excluded by the phrases “in the absence of external heating”, “without external heating”, “the process does not include external heating” and related phrases. Specifically, such endogenous elevation of temperature may result, e.g. from the changing of the pressure inside a closed reactor, in which the reaction takes place or from energy exerted by the dissolution of material in the water. Specifically, throughout the reaction of the process of the current invention, CO₂ as a CO₂ gas may be supplemented which may result in an elevation of the pressure in the reactor. Also, according to the principles of the present invention H₂ gas evolves, which elevates the gas pressure inside the reactor. Hydrogen is considered an ideal gas, and ideal gas temperature generally correlates with its pressure. As a result, endogenous heating may occur, which is not excluded by the definitions presented above. Furthermore, most dissolution processes are exothermic, meaning that upon the formation of a solution from the solvent and the solute (e.g. from water and carbon dioxide) the temperature may rise. This is an additional endogenous heating, which is not excluded by the definitions presented above. An additional factor which may slightly affect the reaction temperature and is not excluded by the phrases above is the mixing, stirring or blending of the reaction contents. Specifically, these mixing processes may result in a slight elevation of temperature due to the kinetic energy they discharge, but are not considered to provide external heating according to the definition of the current invention. It is further to be understood that employment of reaction catalyst(s), initiator(s) or promoter(s) does not exclude a reaction from being considered spontaneous, as these facilitate the kinetics of the reaction, but do not affect the net thermodynamics. As used herein, the process is considered a spontaneous process. The term “spontaneous process” as used herein, refers to a process that does not utilize an external energy in the form of heating or applying an electric current. In certain embodiments, the process is performed with no addition of external electric energy.

In some embodiments, the process is performed at a temperature of 100° C. or less. According to certain embodiments, the step of contacting the water, iron-containing coal combustion product, and CO₂ source is performed at a temperature in the range of −30° C. and 100° C., including each value within the specified range. According to other embodiments, the step of contacting is performed at a temperature in the range of −15° C. and 100° C., including each value within the specified range. According to yet other embodiments, the step of contacting is performed at a temperature in the range of −5° C. and 100° C., including each value within the specified range. According to further embodiments, the step of contacting is performed at a temperature in the range of −5° C. and 80° C., including each value within the specified range. According to particular embodiments, the step of contacting is performed at a temperature in the range of −5° C. and 50° C., including each value within the specified range. According to specific embodiments, the step of contacting is performed at a temperature in the range of 5° C. and 50° C., including each value within the specified range. According to one embodiment, the process is performed at a temperature of 100° C. or less. According to another embodiment, the process is performed at a temperature of 95° C. or less. According to yet another embodiment, the process is performed at a temperature of 90° C. or less. According to some embodiments, the process is performed at a temperature of 85° C. or less. According to other embodiments, the process is performed at a temperature of 80° C. or less. According to further embodiments, the process is performed at a temperature of 75° C. or less. According to additional embodiments, the process is performed at a temperature of 70° C. or less. According to certain embodiments, the process is performed at a temperature of 65° C. or less. According to various embodiments, the process is performed at a temperature of 60° C. or less. According to several embodiments, the process is performed at a temperature of 55° C. or less. According to particular embodiments, the process is performed at a temperature of 50° C. or less.

In some aspects and embodiments, the process comprises contacting water and an iron-containing coal combustion product with a CO₂ source. In other aspects and embodiments, the process comprises contacting water supplemented with a CO₂ source with an iron-containing coal combustion product. As detailed herein, in some embodiments, the CO₂ precursor may comprise a combination of two components, such as, a carbonate compound or a bicarbonate compound, and an acid. Thus, in some embodiments, the process comprises contacting water, a first component of the CO₂ source and an iron-containing coal combustion product with a second component of the CO₂ source. As used herein, the term “contacting” is intended to mean bringing together water, the iron-containing coal combustion product, and the CO₂ source to form a mixture, which may be homogenic or heterogenic with each possibility representing a separate embodiment. The term “contacting” may further refer to dispersing, suspending and/or dissolving the CO₂ source and the iron-containing coal combustion product in the water, optionally with mixing.

According to various embodiments, the mixture of the iron-containing coal combustion product and the water is a viscous suspension. Specifically, it is to be understood that increasing the weight ratio of coal combustion product to water should increase the solid content and thereby also increase the viscosity of the suspension. According to some embodiments, the weight ratio of the iron-containing coal combustion product and the water is in the range of 1:4 to 100:1, including all iterations of ratios within the specified range. For example, the weight ratio of the iron-containing coal combustion product and the water is in the range of 1:3 to 75:1, 1:2 to 50:1, or 1:1.5 to 25:1, including all iterations of ratios within the specified ranges.

According to some aspects and embodiments, the process disclosed herein is performed in a closed reactor. As used herein, the term “closed reactor” refers to a closed system which at least temporarily isolates the reaction mixture contained therein from the surrounding environment and allows build-up of gas pressure by preventing material from departing its enclosure. It is to be understood that closed reactors may include opening(s) and/or a cover, for gaining access to the reaction medium therein, and are not limited to permanently sealed or closed structures. Elements, such as a cover or a port may provide reversible access to the interior of the reactor, such that its closed feature may be limited to the operation period thereof. The reactor may possess any shape including, but not limited to, cylindrical, cubical, and rectangular shapes, and may be composed of a variety of materials including, but not limited to, metals, plastics and ceramics. Each possibility represents a separate embodiment. According to certain embodiments, the reactor is equipped with a mixing mechanism. The mixing mechanism may be based on a mechanical, a magnetic, an ultrasonic, and a high-pressure liquid mixer as is known in the art. According to some embodiments, the reactor contents are mixed by circulating and/or recirculating the reaction mixture by continuous or intermittent flow. The flow can be generated by a pump, such as a high-pressure pump, functionally associated with the reactor. As elaborated above, the various mixing procedures do not entail provision of external energy, as defined with respect to the present invention.

According to certain embodiments, the process comprises the steps of:
(a) dispersing an iron-containing coal combustion product in water;
(b) adding a CO₂ source to the dispersion of step (a); and
(c) maintaining the mixture of step (b) substantially sealed in a closed reactor for a period of time.

According to the principles of the present invention, step (a) may comprise the steps of (a1) dispersing an iron-containing coal combustion product in water in an open setting, and (a2) transferring the dispersion of step (a1) to a closed reactor.

According to other embodiments, step (c) further comprises mixing the mixture formed in step (b). According to some embodiments, step (a) of dispersing an iron-containing coal combustion product in water, may be performed inside a closed reactor.

According to further embodiments, the CO₂ source and the iron-containing coal combustion product are added substantially simultaneously to the water, inside a closed reactor and the formed mixture is maintained substantially sealed in the closed reactor for a period of time. According to some embodiments, the process further comprises mixing the mixture formed upon the addition.

According to various embodiments, the process comprises the steps of:
(a) dispersing the CO₂ source in water;
(b) adding the iron-containing coal combustion product to the dispersion of step (a); and
(c) maintaining the mixture of step (b) substantially sealed in a closed reactor for a period of time.

According to some embodiments, step (a), of dispersing the CO₂ source in water comprises at least partially solubilizing a CO₂ source in the water. According to some embodiments, step (c) further comprises mixing the mixture formed in step (b). According to the principles of the present invention, steps (a) and (b) can be performed in an open setting or in a closed reactor with each possibility representing a separate embodiment.

One of the advantages of the current process is that it produces hydrogen, which may be used as a “green” fuel and contribute to a cleaner environment compared to the usage of fossil fuels, typically used today. A further advantage of the current invention is that the hydrogen produced thereby is of high purity and is substantially devoid of contaminants, which are incompatible with fuels and combustion. According to exemplary embodiments, the hydrogen produced by the present process is produced at a purity of at least 85%. According to other exemplary embodiments, the hydrogen produced by the present process is produced at a purity of at least 90%. It is to be understood that by “purity of at least 85%”, it is meant that the total volume of hydrogen produced by the present process is equal to or greater than 0.85 times the total volume of the reaction products. According to some embodiments, the volume of hydrogen produced by the present process is equal to or greater than 85% of the total gas volume in the reaction at the end of the process.

According to one embodiment, the process further comprises a step of collecting the produced H₂. According to some embodiments, collecting the produced H₂ comprises delivering the H₂ gas to a gas container through a gas pipe. According to other embodiments, the gas pipe is extending from the closed reactor to the gas container. According to additional embodiments, the gas pipe comprises a valve configured to allow the closed reactor to be sealed during the period of time in which reaction occurs. According to further embodiments, the gas valve is configured to allow passage of hydrogen gas from the closed reactor to a gas container thereby enabling the collection of the H₂ that is produced. In particular embodiments, the release system comprises a valve (such as a reverse valve) with a flame retardant and/or bubbler attached. In certain embodiments, the reactor and/or container further comprise a check valve with a flame arrester. The verification of hydrogen gas formation can be performed as is known in the art, for example by using a hydrogen burner.

According to some embodiments, the process further comprises the steps of treating the produced hydrogen gas. According to one embodiment, the treatment step is selected from a group consisting of separation and de-humidification. Each possibility represents a separate embodiment. According to another embodiment, the treatment comprises separating gases other than hydrogen from the hydrogen gas that is formed. It is to be understood that other gasses may be present following the completion of the reaction, such as CO₂, water vapor, gasses present in atmospheric air or in flue gas, etc. H₂ released from the closed reactor can therefore be passed via a gas separation or filtration system, according to some embodiments. The filtration system may comprise absorbents including, but not limited to, silica, zeolite, polymeric absorbents, perovskite, or nano-porous membrane absorbents, enabling the passage of smaller molecules, such as H₂, while blocking the larger molecules, such as, for example CO₂. According to some embodiments, the filtration system comprises a polymeric membrane constructed from at least one polymer selected from the group consisting of polyethylene, polyamides, polyimides, cellulose acetate, polysulphone and polydimethylsiloxane. Each possibility represents a separate embodiment. According to certain embodiments, the post-treatment step comprises de-humidification. Accordingly, the separated hydrogen gas can be passed through a desiccation system comprising a desiccant or a humidity absorbent. According to various embodiments, the desiccant comprises silica, zeolite, polymers or metal-organic frameworks (MOFs) and the like. Each possibility represents a separate embodiment. According to several embodiments, the filtration system is functionally connected to the valve. According to other embodiments, the desiccation system is functionally connected to the valve. Additional post-treatment included within the scope of the present invention is the pressurization and/or liquification of the hydrogen produced.

According to certain aspects and embodiments, the process of the present invention utilizes water, an iron-containing coal combustion product, and a CO₂ source as the reactants in the process. Advantageously, the reactants can be obtained from various sources including waste without the need for purification, pre-treatment or pre-processing. Nonetheless, it is to be understood that each of the reactants can be purified, pre-treated or pre-processed prior to being used in the process of the present invention.

“Water” as used herein refers to any type of an aqueous medium including, but not limited to, tap water, sea water, partially purified water, deionized water, distilled water, brackish water and waste water. Each possibility represents a separate embodiment. According to some embodiments, the water is non-purified water. According to certain embodiments, the water is in the solid phase, the liquid phase or the gaseous phase. Preferably, the water is in the liquid phase, i.e. liquid water.

As used herein, the term “sea water” refers to saline water obtained from a sea or an ocean. Ion concentration in sea water is usually from about 10,000 ppm to about 44,000 ppm, including each value within the specified range. Common ions in seawater are chloride, sodium, sulfate, magnesium, calcium, potassium, bicarbonate, carbonate, strontium, bromide, borate, fluoride, boron, silicate, and iodide.

As used herein, the term “brackish water” refers to water that has a higher salinity as compared to fresh water, but a lower salinity as compared to sea water. Brackish water typically has at least 0.5 grams per liter of dissolved salts. The term “brackish water” can also encompass saline water.

As used herein, the term “deionized water” refers to water that has had almost all of its mineral ions removed, including cations such as sodium, calcium, iron, and copper, and anions such as chloride and sulfate. Deionization is a chemical process that uses specially manufactured ion-exchange resins, which reduce the amount of minerals by exchanging them with hydrogen and hydroxides.

As used herein, the term “distilled water” refers to water that is produced by a process of distillation. Distillation involves boiling the water and then condensing the vapor into a clean container, leaving solid contaminants behind.

The term “waste water” as herein used refers to residential, domestic, commercial and/or industrial liquid waste comprising organic or inorganic material. Usually, the term is used to define aqueous waste containing biological material, for example, one or more of sewage material, storm water and grey water such as, for example, laundry and/or bathroom waste also referred to as sullage. The term “waste water” as used herein also encompasses non-biological and inorganic aqueous waste material, such as water used for cleaning or temperature regulating of industrial machinery. It is to be understood that using waste water for various purposes is both economically and environmentally beneficial, as this type of water would otherwise require rigorous purification process(es) in order to be recycled for subsequent use. According to some embodiments, the water used in the present process comprises waste water.

The term “iron-containing coal combustion product” as used herein includes, but is not limited to, iron-containing coal combustion wastes and iron-containing coal combustion residues selected from coal ash, fly ash, bottom ash, boiler slag, heavy oil ash and a mixture or combination thereof. Each possibility represents a separate embodiment. It can be originated from a power plant, a fuel boiler, or from cement production or other industrial thermal processes. Each possibility represents a separate embodiment. Iron-containing coal combustion products may also be produced by the combustion of other heavy fuel oils, e.g. mazut. Since the chemical composition of coal combustion products (CCPs) varies as a result of the coal source and combustion parameters, the iron-containing coal combustion product used in the process of the present invention may also vary. Typically, the iron-containing coal combustion product comprises from about 2% to about 40% iron oxide, including each value within the specified range. In other embodiments, the iron-containing coal combustion product comprises from about 5% to about 30% iron oxide, including each value within the specified range. In yet other embodiments, the iron-containing coal combustion product comprises less than 25% iron oxide. Exemplary contents of iron oxide within the coal combustion product include, but are not limited to, about 2%, about 5%, about 7%, about 10%, about 15%, about 20%, about 25%, about 30%, about 35%, or about 40%, with each possibility representing a separate embodiment. It is to be understood that that ratios and percentages used herein to define relative amounts of materials are referring to weight ratios and percentages. For examples, a coal combustion product, which weighs 100 gram and comprises 15 grams of iron oxide and 85 grams of other chemical compounds, is consider to be an iron-containing coal combustion product comprising 15% iron oxide. It is further to be understood that if a coal combustion product includes a number of different iron oxides (e.g. Fe in different oxidation states), the total amount of iron oxides is to be considered in the calculation of percentages. For examples, a coal combustion product, which weighs 100 gram and comprises 5 grams of iron(II) oxide (FeO), 5 grams of iron(II,III) oxide (Fe₃O₄), 10 grams of iron(III) oxide (Fe₂O₃) and 80 grams of other chemical compounds, is consider to be an iron-containing coal combustion product comprising 20% iron oxide.

The term “iron oxide”, as used herein refers to any compound comprising a chemical bond between an Fe atom and an O atom. According to some embodiments, the iron oxide comprises a divalent iron oxide, a trivalent iron oxide or a combination thereof. Each possibility represents a separate embodiment. In one embodiment, the iron oxide comprises a trivalent iron oxide. In several embodiments, the iron oxide comprises at least one of iron(II) oxide (FeO), iron(II,III) oxide (Fe₃O₄), iron(III) oxide (Fe₂O₃), and combinations thereof. According to other embodiments, the iron oxide is selected from the group consisting of iron(II) oxide (FeO), iron(II,III) oxide (Fe₃O₄), iron(III) oxide (Fe₂O₃), and combinations thereof. In other embodiments, the iron oxide is selected from the group consisting of iron(II,III) oxide (Fe₃O₄), iron(III) oxide (Fe₂O₃), and combinations thereof.

The coal combustion product typically also comprises as a major constituent silicon dioxide in a weight percent of from about 25% to about 75% silicon dioxide, including each value within the specified range. Exemplary amounts of silicon dioxide (either silica or quartz) include, but are not limited to, about 25%, about 30%, about 35%, about 40%, about 45%, about 50%, about 55%, about 60%, about 65%, about 70%, or about 75%, with each possibility representing a separate embodiment. In additional embodiments, the ratio between the iron oxide and the silicon dioxide in the iron-containing coal combustion product is in the range of about 1:1.5 to about 1:10, including all iterations of ratios within the specified range. In exemplary embodiments, the weight percent ratio of the iron oxide and the silicon dioxide in the iron-containing coal combustion product includes ratios of about 1:1.5, about 1:2, about 1:2.5, about 1:3, about 1:3.5, about 1:4, about 1:4.5, about 1:5, about 1:5.5, about 1:6, about 1:6.5, about 1:7, about 1:7.5, about 1:8, about 1:8.5, about 1:9, about 1:9.5, or about 1:10, with each possibility representing a separate embodiment. In addition, the coal combustion product typically also includes additional oxides such as, but not limited to, TiO₂, Al₂O₃, CaO, MgO, K₂O, Na₂O, and SO₃. The total amounts of the aforementioned additional oxides vary and are typically within the range of about 20% to about 50%, including each value within the specified range. By way of illustration and not limitation, the weight percent of TiO₂ is in the range of about 0.2% to about 3%, the weight percent of Al₂O₃ is in the range of about 5% to about 35%, the weight percent of CaO is in the range of about 1% to about 35%, the weight percent of MgO is in the range of about 0.1% to about 8%, the weight percent of K₂O is in the range of about 0.05% to about 4%, the weight percent of Na₂O is in the range of about 0.1% to about 3%, and the weight percent of SO₃ is in the range of about 0.1% to about 2.5%, including each value within the specified ranges. Further minor components of the coal combustion products include, but are not limited to, MnO, P₂O₅, SrO, and ZrO₂, the total amount of which by weight percent is typically about 5% or less.

As detailed herein, the coal combustion product may be available at different particle or granule sizes (whether ash or slag), depending on the production. Typically, reactions of such insoluble solids are facilitated, when the solid has a large surface to bulk area. Therefore, the iron-containing coal combustion product may be provided in the form of granules having at least one dimension, which is sufficiently small/narrow, so as to enable a fast reaction, according to some embodiments.

Granularity generally refers to the extent to which a material or system is composed of distinguishable pieces. It can either refer to the extent to which a larger entity is subdivided, or the extent to which groups of smaller indistinguishable entities have joined together or aggregated to become larger distinguishable entities. The term “granule” as used herein, refers to the distinguishable pieces in the granulate. According to some embodiments, each granule is substantially spherical having a diameter in the range of about 0.1 to about 3 millimeters, including each value within the specified range.

According to some embodiments, the iron-containing coal combustion product comprises three-dimensional granules, wherein at least one of the dimensions thereof is smaller than 1 centimeter. According to other embodiments, at least one of the dimensions of the iron-containing coal combustion product granules is smaller than 0.5 centimeter. According to yet other embodiments, at least one of the dimensions of the iron-containing coal combustion product granules is smaller than 0.35 centimeter. According to additional embodiments, at least one of the dimensions of the iron-containing coal combustion product granules is smaller than 0.25 centimeter. According to further embodiments, at least one of the dimensions of the iron-containing coal combustion product granules is smaller than 0.15 centimeter. According to particular embodiments, at least one of the dimensions of the iron-containing coal combustion product granules is smaller than 0.1 centimeter.

The iron-containing coal combustion product may be pre-treated prior to its addition into the reactor. In some embodiments, pretreatment comprises milling or grinding the iron-containing coal combustion product. Typically milling or grinding is performed to obtain to particles having an average particle size of less than about 100 μm. According to some embodiments, the process further comprises a step of milling or grinding the iron-containing coal combustion product to a powder. Milling or grinding, can be performed using any suitable method, e.g., milling, crushing, cutting, using any suitable device, e.g., vortex mill, jet mill, conical mill, ball mill, SAG mill, pebble mill, roller press, buhrstone mill, VSI mill, tower mill or combinations thereof. Each possibility represents a separate embodiment. According to certain embodiments, milling or grinding is performed to obtain particles having an average particle size of less than about 100 μm, less than about 75 μm, less than about 50 μm, less than about 25 μm, less than about 10 μm, or even less than about 5 μm. Each possibility represents a separate embodiment. Currently preferred size ranges include sizes of about 1 μm to about 10 μm, for example about 1 μm to about 5 μm, or about 3 μm to about 5 μm, including each value within the specified ranges. According to some embodiments, the milled iron-containing particles have an average particle size in the range of about 0.1 to about 0.9 mm, including each value within the specified range. According to other embodiments, the milled iron-containing particles have an average particle size in the range of about 0.15 to about 0.65 mm, including each value within the specified range. According to further embodiments, at least 50% of the total mass of the milled iron-containing particles is composed of particles having an average particle size in the range of about 0.1 to about 0.9 mm. According to some embodiments, at least 60% of the total mass of the milled iron-containing particles is composed of particles having an average particle size in the range of about 0.1 to about 0.9 mm. According to other embodiments, at least 65% of the total mass of the milled iron-containing particles is composed of particles having an average particle size in the range of about 0.1 to about 0.9 mm. According to yet other embodiments, at least 70% of the total mass of the milled iron-containing particles is composed of particles having an average particle size in the range of about 0.1 to about 0.9 mm. According to additional embodiments, at least 75% of the total mass of the milled iron-containing particles is composed of particles having an average particle size in the range of about 0.1 to about 0.9 mm. According to some embodiments, at least 50% of the total mass of the milled iron-containing particles is composed of particles having an average particle size in the range of about 0.15 to about 0.65 mm. According to other embodiments, at least 60% of the total mass of the milled iron-containing particles is composed of particles having an average particle size in the range of about 0.15 to about 0.65 mm. According to yet other embodiments, at least 65% of the total mass of the milled iron-containing particles is composed of particles having an average particle size in the range of about 0.15 to about 0.65 mm. According to further embodiments, at least 70% of the total mass of the milled iron-containing particles is composed of particles having an average particle size in the range of about 0.15 to about 0.65 mm. According to additional embodiments, at least 75% of the total mass of the milled iron-containing particles is composed of particles having an average particle size in the range of about 0.15 to about 0.65 mm.

While the inventor of the present invention surprisingly discovered that it is possible to produce hydrogen at high purity even when using a coal combustion product containing less than 25% by weight of iron oxides, for example using slag containing about 5-10% iron oxides, the present invention further contemplates iron enrichment of the iron-containing coal combustion product or the ground iron-containing coal combustion product. Typically, enrichment is affected such that the total amount or iron oxides increases by at least 10% of the initial amount, for example the total amount of iron oxides may be increased in at least about 10%, about 20%, about 30%, about 40%, about 50%, about 60%, about 70%, about 80%, about 90%, about 100%, about 150%, about 200%, or more. Each possibility represents a separate embodiment. Enrichment can be performed by various methods known in the art such as, but not limited to, beneficiation and leaching. Beneficiation processes include, among others, particle sizing, density separation, magnetic separation, and froth flotation. Each possibility represents a separate embodiment. Particle and magnetic separations using air classification and/or magnetic sieving are currently preferred due to the magnetic properties of iron. For example, cross belt and overband magnetic separators are commercial devices, whereby automatic magnetic separation may be performed.

Additional pre-treatment that can be performed on the coal combustion product includes, but is not limited to, washing with a washing solution selected from the group consisting of an aqueous solution, an acidic solution, a basic solution, an organic solvent, and a combination thereof. Each possibility represents a separate embodiment. Suitable acid solutions include, but are not limited to, sulfuric acid, phosphoric acid, hydrochloric acid, acetic acid, and citric acid. Each possibility represents a separate embodiment. Suitable base solutions include, but are not limited to, sodium hydroxide, potassium hydroxide, and ammonium hydroxide. Each possibility represents a separate embodiment.

While the present invention is primarily directed to the production of hydrogen from water, a CO₂ source and an iron-containing coal combustion product in the absence of external heating, it is contemplated that other high valent iron sources can be used according to the principles disclosed herein. Thus, in some aspects and embodiments, the present invention provides a process for producing H₂, the process comprising a step of contacting water, a high valent iron-containing substance, and a CO₂ source selected from the group consisting of CO₂ and a CO₂ precursor thereby producing H₂, wherein the process is performed in a reactor in the absence of external heating. The high valent iron-containing substance includes, but is not limited to, iron ores containing magnetite, hematite, goethite, limonite or siderite; and high valent iron waste derived from water treatment, bauxite processing (red mud), mineral paints, solid industrial waste of metallurgical, chemical, and mechanical engineering plants (e.g. semiconductor production), and the steel industry. Each possibility represents a separate embodiment.

The steel industry usually utilizes iron originating from iron ore mines, ore beneficiation plants, coal mines, coal cleaning plants, and coke plants. Each possibility represents a separate embodiment. Typically, steel production involves hot processing in presence of oxygen containing gases (e.g. air) that corrode the steel surface into iron oxide thereby forming a layer termed scale on the surface steel. The iron oxides including iron (II) oxide, FeO, iron (III) oxide, Fe₂O₃, and iron (II,III) oxide, Fe₃O₄, can be used in the process disclosed herein. According to various embodiments, the high valent iron-containing substance can be derived from pig iron production, steel making, rolling operations and finishing operations common in steel milling, i.e. cold reduction, tin plating, galvanizing, and hot rolling. Each possibility represents a separate embodiment.

According to some aspects and embodiments, the CO₂ source is CO₂. According to other embodiments, the CO₂ source is CO₂ provided as CO₂ gas. It is to be understood that in atmospheric conditions, CO₂ is in a gas state, however, in elevated gas pressure conditions and moderate temperatures, CO₂ may be in an equilibrium between a gas, a liquid and supercritical CO₂. It is further to be understood that depending on the environmental pressure and temperature, CO₂ differs in its aqueous solubility. Thus, the CO₂ provided as CO₂ gas may be present in different phases during the reaction progression, including gas, liquid, supercritical, solid (dry ice), and dispersed in the water. Each possibility represents a separate embodiment.

CO₂, provided as CO₂ gas has several advantages. Specifically, the utilization of CO₂ gas as a starting material contributes to Carbon Capture and Storage. In this manner, in addition to the production of hydrogen that can be used as a “green” fuel and the recycling of coal combustion products, the present invention further provides an additional environmental benefit which is CO₂ sequestering. The term “Carbon Capture and Storage” (CCS, also referred to as “Carbon Capture” and “Sequestration”), as used herein refers to the process of managing produced carbon dioxide, transporting it to a storage site, and depositing it where it will not enter or re-enter the atmosphere. Specifically, the CO₂ is mainly a combustion waste emitted from large point sources, such as fossil fuel power plants. If the CO₂ is removed from the atmosphere, then the process could alternatively be defined as Carbon Dioxide Removal (CDR). Thus, it is an environmental advantage to use CO₂ gas in the process thereby contributing to its capturing. According to some embodiments, the process comprises a step of streaming a gas containing CO₂. In other embodiments, the step of streaming a gas additionally comprises a step of concentrating the CO₂. In yet other embodiments, the process comprises a step of capturing atmospheric CO₂. In additional embodiments, the process comprises a step of streaming CO₂ generated by a CO₂ producing source. In some embodiments, the process of the present invention further comprises capturing CO₂ as an iron complex thereby resulting in Carbon Capture and Utilization (CCU).

Importantly, the CO₂ gas is not required to be of specific high purity according to some embodiments. Even as little as 0.5% CO₂ can be used in the process according to certain embodiments of the present invention. Thus, according to some embodiments, various sources of CO₂ gas may be used as the CO₂ source of the current process. According to various embodiments, the process further comprises a step of capturing atmospheric carbon dioxide. According to other embodiments, the process further comprises a step of concentrating the atmospheric carbon dioxide. According to yet other embodiments, at least part of the CO₂ source is CO₂ gas provided from a power plant, a biogas plant, a distillery, refinery, combustion engine, cement production plant, ammonia plant, steel, and iron plant. Each possibility represents a separate embodiment. According to additional embodiments, the process further comprises a step of decontaminating the flue gas and/or concentrating the CO₂ provided by a CO₂ producing plant. According to further embodiments, at least part of the CO₂ source is flue gas comprising CO₂.

The term “flue gas” refers to a gas that is released to the atmosphere via a flue, which is a pipe or channel for conveying exhaust gases from a fireplace, oven, furnace, boiler or steam generator. Often, it refers to the combustion exhaust gas produced at power plants.

The utilization of flue gas as the CO₂ source has an evident economic and environmental advantage, as flue gases are significant contributors to air pollution, the greenhouse effect, and are facing severe regulatory actions in recent years.

According to other embodiments, the process further comprises a step of decontaminating the flue gas and/or concentrating the CO₂ in the flue gas. Specifically, typical contaminants in such industrial plant may comprise sulfur-containing compounds, such as sulfur oxides and nitrogen-containing compounds, such as nitric oxides. In certain embodiments, CO₂ contaminants include metals such as mercury. Known decontamination methods involve technologies including, but not limited to, chemical reaction processes, physical and electrochemical methods. According to other embodiments, the CO₂ source is CO₂ provided as dry ice.

It is to be understood that the CO₂ source of the current process is not limited to carbon dioxide gas, and may by a CO₂ precursor, which includes two reactants, which upon reaction, produce carbon dioxide. According to some embodiments, the CO₂ source is a CO₂ precursor or generator. According to various embodiments, the CO₂ precursor comprises a combination of carbonate compounds or bicarbonate compounds, and an acid. According to other embodiments, the process further comprises contacting a carbonate compound or a bicarbonate compound with the water and the iron-containing coal production product, and adding an acid to the formed dispersion. According to additional embodiments, the acid addition is performed gradually. According to certain embodiments, the process further comprises contacting CO₂ with the water and the iron-containing coal production product, and adding a base to the formed dispersion. According to some embodiments, the process further comprises adding a base to the water and then contacting CO₂ with the basic water.

It is to be understood by the skilled in the art that CO₂ forms upon a chemical reaction between a bicarbonate and an acid. Similarly, a bicarbonate forms upon a chemical reaction between a carbonate and an acid, where the bicarbonate may further react with an acid to form CO₂.

According to some embodiments, the CO₂ precursor comprises a carbonate selected from the group consisting of calcium carbonate, sodium carbonate, potassium carbonate, iron(II) carbonate, ammonium carbonate, magnesium carbonate, and combinations thereof. Each possibility represents a separate embodiment. The carbonate anion is represented by the chemical formula CO₃²⁻. According to other embodiments, the CO₂ precursor comprises a bicarbonate selected from the group consisting of calcium bicarbonate, sodium bicarbonate, potassium bicarbonate, iron(II) bicarbonate, ammonium bicarbonate, magnesium bicarbonate, and combinations thereof. Each possibility represents a separate embodiment. The bicarbonate anion is represented by the chemical formula HCO₃⁻. According to additional embodiments, the CO₂ precursor comprises carbonic acid.

According to certain embodiments, the carbon dioxide concentration in the dispersion formed from the CO₂ source, the water, and the iron-containing coal production product is at least 1%, for example about 1% to about 50%, including each value within the specified range. Exemplary percentages include, but are not limited to, about 1%, about 2%, about 3%, about 5%, about 7.5%, about 10%, about 15%, about 20%, about 25%, about 30%, about 35%, about 40%, about 45%, or about 50%, with each possibility representing a separate embodiment. It will be appreciated to those skilled in the art that carbonic acid (H₂CO₃) is formed upon the contacting of CO₂ and water, and the pH is lowered to below 7. According to some embodiments, the CO₂ source and the water are contacted prior to addition of the iron-containing coal combustion product, such that an aqueous solution of carbonic acid is formed having pH ranging from about 5.5 to about 6.5, including each value within the specified range. The solution can be prepared in a reactor or pre-prepared in a saturation unit. According to some embodiments, the saturation unit is pre-cooled to a temperature below 10° C. The saturation unit can be a Gas Addition Module, a Saturator Column or a pressure pump. Each possibility represents a separate embodiment. If the solution is prepared outside the reactor, a high-pressure pump is used to load the solution into the reactor. Once prepared, the solution is typically kept under pressure. According to some embodiments, the pressure is higher than 1 Bar.

According to various embodiments, upon contacting the CO₂ source with the water, the pressure within the closed reactor is in the range of 1 Bar to about 350 Bar, including each value within the specified range. Typical ranges of pressures within the closed reactor include, but are not limited to, about 40 to about 350 Bar, about 1 to about 100 Bar, about 100 to about 350 Bar, or about 100 to about 250 Bar, including each value within the specified ranges. Exemplary pressures include, but are not limited to, about 1, about 5, about 10, about 20, about 50, about 100, about 150, about 200, about 250, or about 300 Bar, with each possibility representing a separate embodiment. In one embodiment, the pressure within the closed reactor is above the ambient pressure. According to some embodiments, the pressure within the closed reactor is at least 1 Bar.

It is to be understood that upon the reaction progression, H₂ gas is formed, which elevates the internal gas pressure within the closed reactor, according to some embodiments. Specifically, unlike carbon dioxide, which tends to condense into a liquid or solid in high pressure, hydrogen does not share a similar tendency, resulting in a significant increase of the pressure inside the closed reactor, according to some embodiments.

According to some aspects and embodiments, the period of time for the reaction between water, the iron-containing coal combustion product, and the CO₂ source, according to the principles of the present invention is at least 30 minutes, for example from about 30 minutes to about 1 week, including each value within the specified range. According to some aspects and embodiments, the period of time for the reaction between water, the iron-containing coal combustion product, and the CO₂ source, according to the principles of the present invention is at least 60 minutes, for example about 60 minutes to about 100 hours including each value within the specified range. Exemplary time periods during which the reactions take place include, but are not limited to, about 30 minutes, about 1 hour, about 2 hours, about 3 hours, about 4 hours, about 5 hours, about 6 hours, about 7 hours, about 8 hours, about 10 hours, about 12 hours, about 15 hours, about 18 hours, about 20 hours, about 22 hours, about 24 hours, about 48 hours, about 72 hours, about 4 days, about 5 days, about 6 days or about 7 days, with each possibility representing a separate embodiment.

In some embodiments, the process further comprises adding glycerin to the reaction.

It was found that the reaction mixture of the current process is typically mildly acidic. In some embodiments, following dissolution of CO₂ in water, mildly acidic pH is obtained without the addition of an acid. However, addition of an acid or base to the reaction mixture is also contemplated by the present invention. According to some embodiments, the process further comprises a step of adding an acid to the water. According to other embodiments, the step of adding an acid is conducted after reaction initiation. According to yet other embodiments, the acid is selected from a group consisting of sulfuric acid, phosphoric acid, hydrochloric acid, acetic acid, and citric acid. Each possibility represents a separate embodiment. According to some embodiments, the acid comprises hydrochloric acid.

According to some embodiments, the step of adding the acid precedes the step of adding the CO₂ source. According to some embodiments, the process comprises the steps of (a) dispersing the iron-containing coal combustion product in water; (b) adding an acid to the dispersion of step (a); and (c) adding a CO₂ source to the dispersion of step (b) thereby generating a reaction and producing hydrogen.

According to some embodiments, upon contacting the CO₂ source, the iron-containing coal combustion product and the water, an aqueous dispersion is formed, wherein the dispersion has a pH of 6.5 or less. According to various embodiments, the reaction pH is lower than 6.5, for example in the range of about 4 to about 6, including each value within the specified range. Alternatively, the pH of the reaction may be higher than 6.5, for example in the range of about 7 to about 10, including each value within the specified range. If basic conditions are desired, the process may further comprise the addition of a base to the water. According to other embodiments, the step of adding a base is conducted after reaction initiation. According to yet other embodiments, the base is selected from a group consisting of sodium hydroxide, potassium hydroxide, and ammonium hydroxide. Each possibility represents a separate embodiment

According to some embodiments, the process further comprises a step of adding an anti-caking agent to the reaction mixture. Without being bound by any theory or mechanism of action, an anti-caking agent facilitates the production of hydrogen, decreases the reaction duration, acts as a dispersant, affects the adsorption properties, and prevents agglomeration or clumping of the iron-containing coal combustion product. Suitable anti-caking agents within the scope of the present invention include, but are not limited to, tricalcium phosphate, powdered cellulose, magnesium stearate, sodium ferrocyanide, potassium ferrocyanide, calcium ferrocyanide, calcium phosphate, sodium silicate, silicon dioxide, calcium silicate, magnesium trisilicate, talcum powder, sodium aluminosilicate, potassium aluminum silicate, calcium aluminosilicate, bentonite, aluminum silicate, stearic acid, polydimethylsiloxane, and a mixture or combination thereof. Each possibility represents a separate embodiment. Currently preferred is the use of silicon dioxide in the form of silica, such as fumed silica.

The anti-caking agent may be added to the dispersion comprising the water, the iron-containing coal production product, and the CO₂ source at a concentration of between 1% and 10% w/w, including each value within the specified range. According to certain embodiments, the addition supplements the anti-caking agent which constitutes part of the iron-containing coal production product. According to some embodiments, the anti-caking agent is a surfactant that has an amphiphilic structure. According to other embodiments, the anti-caking agent comprises at least one functional group selected from a group consisting of —OH, —COOH, —SOOOH, and salts thereof. Each possibility represents a separate embodiment. According to some embodiments, the anti-caking agent is selected from a group consisting of silica compounds, fumed silica, and pyrogenic silicon dioxide.

It is to be understood that by using an iron-containing coal production product which contains significant amounts of silicon dioxide, the addition of anti-cacking agent can be avoided. Accordingly, the aforementioned advantages are already obtained in the absence of an external anti-caking agent. Nonetheless, in some embodiments, an external anti-caking agent as described hereinabove is added.

Although addition of specific additives as detailed above may contribute to specific parameters of the present invention, some implementations of the production of hydrogen may benefit from the absence of additives, such as organic compounds. According to some embodiments, the process does not include the addition of organic compounds. According to other embodiments, the process does not include the addition of compounds other than the water, the iron-containing coal combustion product, and the CO₂ source.

The process presented herein may be performed using a closed reactor, which is typically suitable for performing reactions involving a gas as a product and/or as a stating material, according to some embodiments. The reaction may be conducted batch-wise or continuously, with each possibility representing a separate embodiment. Specifically, according to some embodiments, the reaction may be performed as a batch process (e.g. in a batch reactor), for producing separate batches of hydrogen in separate reactions, or it may be performed as a continuous process using a series of batch reactors or a continuous flow reactor for continuous production of hydrogen. Provided below are non-limiting examples of conventional reactors, in which reactions, such as the reaction of the current invention, may take place.

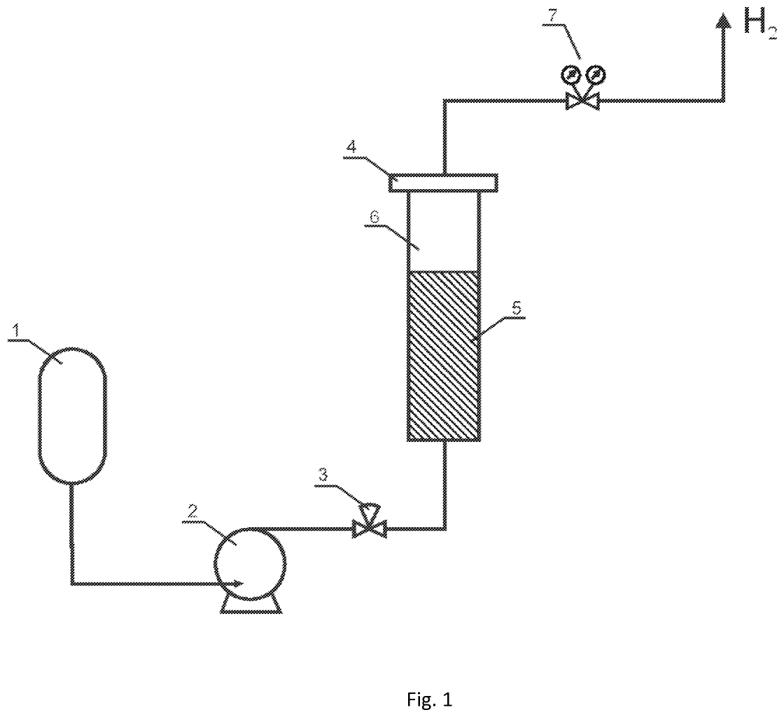

Reference is now made to FIG. 1. It is within the scope of this invention that the process is performed as a batch process for the production of hydrogen. FIG. 1 represents a standard configuration of a system for batch production of hydrogen according to some embodiments. In accordance with these embodiments, the system comprises a reactor 4 for conducting the reaction, a carbon dioxide tank 1, configured to store carbon dioxide required for the reaction, a compressor 2, configured to elevate and/or regulate the carbon dioxide gas entering reactor 4. According to some embodiments, the system further comprises a ball valve 3, configured to regulate flow of carbon dioxide gas from carbon dioxide tank 1 to reactor 4. In this configuration, carbon dioxide is added at the bottom of the reactor and dispersed in the reaction slurry. According to other embodiments, reactor 4 comprises gas storage area 6 and an area for the aqueous dispersion 5. According to further embodiments, the system for batch production of hydrogen further comprises a ball valve and a pressure regulator 7, for determining the pressure inside reactor 4.

In some embodiments, reactor 4 comprises at least one mixing unit (not shown). The reactor should be constructed from a non-reactive material, capable of withstanding pressure of up to 350 Bar. The mixing unit can be based on a mechanical, a magnetic, an ultrasonic, and a high-pressure liquid mixer as is known in the art. In one embodiment, the aqueous dispersion is mixed by circulation.

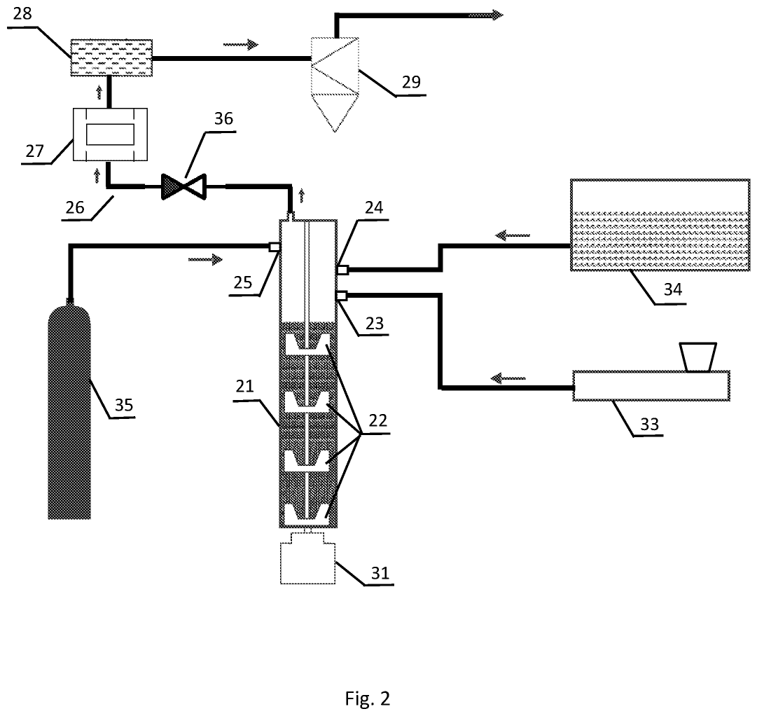

Reference is now made to FIG. 2. It is within the scope of this invention that the process is performed as a continuous (flow) process for the production of hydrogen, for example in reactor 21, as presented herein. The reactor 21 may be constructed from a non-reactive material, capable of withstanding pressure of up to 350 Bar or more. In some embodiments, the reactor 21 comprises at least one mixing unit 22 which can be active, passive or static. Each possibility representing a separate embodiment. Active mixing units 22 can be based on mechanical, magnetic, ultrasonic, or high-pressure liquid mixers as is known in the art, powered by a mechanical or magnetic motor 31. Each possibility represents a separate embodiment. In some embodiments, the mixture within reactor 21 is mixed by circulation. In other embodiments, the reactor 21 comprises at least one feeding/loading opening 23 24 25, suitable for the continuous adding of the reactants (as solids 33, liquids 34 and/or gases 35), according to some embodiments. In further embodiments, the reactor includes a gas release system 26 comprising a controller, such as a one-way valve 36 or a facet.

In some embodiments, release system 26 may also comprise a system for treating the hydrogen gas produced by the reaction. The system may hence comprise a gas separation or filtration system 27 comprising absorbents such as, but not limited to, silica, zeolite, polymeric absorbents, perovskite or nano-porous membrane, enabling the passage of smaller molecules, such as H₂, while blocking the larger molecules, such as CO₂. Each possibility represents a separate embodiment. In some embodiments, the polymeric membrane comprises polyethylene, polyamides, polyimides, cellulose acetate, polysulphone, polydimethylsiloxane, or palladium membranes. Each possibility represents a separate embodiment. A pressure swing adsorption system can also be used. The system may also comprise an additional desiccant or moisture absorbent system 28 which may comprise an absorbent such as, but not limited to, silica, zeolite, polymers or metal-organic frameworks. The treated hydrogen can then be piped for further use, compression, liquification, or storage. The reactor further comprises a system for the removal of the reacted solids and/or liquids 29.

As used herein and in the appended claims, the singular forms “a”, “an”, and “the” include plural references unless the context clearly dictates otherwise. Thus, for example, reference to “an iron-containing coal combustion product” includes a plurality of coal combustion products. It should be noted that the term “and” or the term “or” is generally employed in its sense including “and/or” unless the context clearly dictates otherwise. As used herein, the term “about” is meant to encompass variations of ±10%.

### EXAMPLES

The following examples are presented in order to more fully illustrate certain embodiments of the invention. They should in no way, however, be construed as limiting the broad scope of the invention. One skilled in the art can readily devise many variations and modifications of the principles disclosed herein without departing from the scope of the invention.

### Example 1

1,000 gr of waste from the boiler of a coal fired power plant (‘iron slag’) was milled to an average particle size of 3.0±0.5 microns. The elemental constituents of the iron slag used are outlined in Table 1 hereinbelow. 320 ml of water were mixed with the milled iron slag in a 1,000 ml reactor at room temperature (25° C.). Following mixing, 13% aqueous solution of hydrochloric acid (Sigma Aldrich) was added to reach a pH of 5. Then, 78 gr of carbon dioxide (Technical grade, Sigma Aldrich) were added to the reactor and a pressure of 50 Bar was measured in the reactor. The reactor was kept sealed for 24 hours. During the reaction, the internal pressure was built up to 250 Bar and a temperature of 38° C. was reached. No external energy was supplied. The reaction was completed, producing 14 gr of hydrogen at a purity of 91.7%.

TABLE 1
Elemental analysis of iron slag
Iron Slag

| | Fraction, |
|---|---|
| Element | % of Mass |
| Al | 8 ± 5 |
| Si | 55 ± 3 |
| S | 11 ± 1 |
| Cr | 1.0 ± 0.2 |
| Mn | 0.75 ± 0.08 |
| Fe | 20 ± 1 |
| Zn | 0.86 ± 0.07 |

### Example 2

Twenty five hundred milliliters (2,500 ml) of water were mixed with 3,000 gr of iron waste from a coal fired power plant (‘iron slag’, enriched using a magnetic belt filter) in a 10 L reactor at room temperature (25° C.). Following the mixing, 300 gr of carbon dioxide (Technical grade, Sigma Aldrich) were added to the reactor and a pressure of 50 atm was measured in the reactor. The reactor was kept sealed for 48 hours. During the reaction the internal pressure built up to 160 atm and a temperature of 38° C. was reached. No external energy was supplied.

The reaction was completed, producing 125 gr of hydrogen at a purity of 99.75%. Gas analysis revealed that the level of CO₂ and other gases was very low (Table 2).

TABLE 2
Analysis of hydrogen gas produced

| Properties | Units | Results |
|---|---|---|
| Hydrogen | % vol. | 99.75 |
| Oxygen | ppm vol. | 0.3 |
| Nitrogen | ppm vol. | 0.18 |
| Carbon Monoxide | ppm vol. | 6 |
| Methane | ppm vol. | 10 |
| Carbon Dioxide | % vol. | 0.0292 |

### Example 3

Example 2 was repeated with iron waste from a coal fired power plant (‘iron slag’, enriched using a magnetic belt filter) in a 10 L reactor at room temperature (25° C.). Following the mixing, 300 gr of carbon dioxide (Technical grade, Sigma Aldrich) were added to the reactor and a pressure of 50 atm was measured in the reactor. The reactor was kept sealed for 15 hours. During the reaction the internal pressure built up to 110 atm. No external energy was supplied.

The reaction was incomplete, producing 112 gr of hydrogen at a purity of 90.7%. Gas analysis revealed that the level of CO₂ at that point was 9.21% and the level of the other gases was very low (Table 3).

TABLE 3
Analysis of hydrogen gas produced

| Properties | Units | Results |
|---|---|---|
| Hydrogen | % vol. | 90.7 |
| Methane | ppm vol. | 65 |
| Other Hydrocarbons | ppm vol. | 73 |
| Oxygen | ppm vol. | 34 |
| Nitrogen | ppm vol. | 725 |
| Carbon Monoxide | ppm vol. | <0.14 |
| Carbon Dioxide | % vol. | 9.21 |

While certain embodiments of the invention have been illustrated and described, it is to be clear that the invention is not limited to the embodiments described herein. Numerous modifications, changes, variations, substitutions and equivalents will be apparent to those skilled in the art without departing from the spirit and scope of the present invention as described by the claims, which follow.

1. A process for producing H₂, the process comprising a step of contacting water, an iron-containing coal combustion product, and a CO₂ source selected from the group consisting of CO₂ and a CO₂ precursor thereby producing H₂, wherein the process is performed in a reactor in the absence of external heating.

2. The process of claim 1, which is performed at a temperature of 100° C. or less.

3. The process of claim 1, which is performed at a temperature of about −5° C. to about 50° C.

4. The process of claim 1, which is performed with no addition of external electric energy.

5. The process of claim 1 further comprising a step of collecting the produced H₂.

6. The process of claim 1, further comprising a step of post-treating the produced H₂, wherein post-treating comprises at least one of gas separation, filtration, liquification and drying.

7-9. (canceled)

10. The process of claim 1, wherein the water is selected from the group consisting of tap water, sea water, partially purified water, deionized water, distilled water, brackish water, and waste water.

11. The process of claim 1, wherein the iron-containing coal combustion product is selected from the group consisting of coal ash, fly ash, bottom ash, boiler slag, heavy oil ash, and a mixture or combination thereof.

12. The process of claim 1, wherein the iron-containing coal combustion product originates from a power plant, a fuel boiler, or from cement production.

13. The process of claim 1, wherein the iron-containing coal combustion product comprises a divalent iron oxide, a trivalent iron oxide or a combination thereof.

14. The process of claim 1, wherein the iron-containing coal combustion product comprises a trivalent iron oxide.

15. The process of claim 1, wherein the iron-containing coal combustion product comprises at least one of iron(II) oxide (FeO), iron(II,III) oxide (Fe₃O₄), and iron(III) oxide (Fe₂O₃).

16. The process of claim 1, wherein the iron-containing coal combustion product comprises from about 2% to about 40% iron oxide w/w.

17. The process of claim 16, wherein the iron-containing coal combustion product further comprises from about 25% to about 75% silicon dioxide w/w.

18. The process of claim 1, further comprising pretreating the iron-containing coal combustion product prior to the step of contacting water, an iron-containing coal combustion product, and a CO₂ source, wherein pretreating comprises at least one of milling the iron-containing coal combustion product and enriching the iron content of the iron-containing coal combustion product.

19. (canceled)

20. The process of claim 1, wherein the CO₂ source is a CO₂ gas, wherein the CO₂ gas is originated from at least one of pure industrial CO₂, flue gas, a CO₂-producing plant, and atmospheric CO₂.

21. (canceled)

22. The process of claim 20, wherein the CO₂ gas is atmospheric CO₂ and the process further comprises atmospheric CO₂ sequestering.

23-26. (canceled)

27. The process of claim 1, which is performed at a pH of 6.5 or less.

28-29. (canceled)

30. The process of claim 1, further comprising adding an anti-caking agent to the reactor, wherein the anti-caking agent is selected from the group consisting of tricalcium phosphate, powdered cellulose, magnesium stearate, sodium ferrocyanide, potassium ferrocyanide, calcium ferrocyanide, calcium phosphate, sodium silicate, silicon dioxide, calcium silicate, magnesium trisilicate, talcum powder, sodium aluminosilicate, potassium aluminum silicate, calcium aluminosilicate, bentonite, aluminum silicate, stearic acid, polydimethylsiloxane, and a mixture or combination thereof.

31-35. (canceled)

36. The process of claim 1, further comprising CO₂ capture and storage and/or recycling of the coal combustion product.

37. (canceled)
